(19) United States
(12) Patent Application Publication
(10) Pub. No.: US 2024/0411239 A1
(43) Pub. Date: Dec. 12, 2024

(54) CHARGING DEVICE, IMAGE FORMING APPARATUS, AND CLEANING METHOD

(71) Applicant: Konica Minolta, Inc., Tokyo (JP)

(72) Inventor: Yutaka MIZOTA, Toyokawa-shi (JP)

(21) Appl. No.: 18/677,072

(22) Filed: May 29, 2024

(30) Foreign Application Priority Data
Jun. 7, 2023 (JP) 2023-093728

(51) Int. Cl. G03G 15/02; B08B 1/14; B08B 1/32; G03G 21/16

(52) U.S. Cl. CPC G03G 15/0258; B08B 1/14; B08B 1/32; G03G 21/1633

(57) ABSTRACT

A charging device includes a discharging member, a cleaning member, a conveying screw engaged with the cleaning member by screw action and configured to move the cleaning member when it is rotated, a driving device configured to rotationally drive the conveying screw, a detachable member, and a handle provided on an end portion side opposite to the driving device side in a longitudinal direction of the conveying screw. The detachable member allows the driving device and the conveying screw to be detached from each other in a longitudinal direction of the conveying screw on a driving device side. The handle allows the cleaning member to be manually moved along the discharging member after the driving device and the conveying screw are disengaged by the detachable member. The cleaning member has a home position at the driving device side in the longitudinal direction of the conveying screw.

### CROSS REFERENCE TO RELATED APPLICATIONS

The present invention claims priority under 35 U.S.C. § 119 Japanese Patent Application No. 2023-093728, filed on Jun. 7, 2023, the entire content of which is incorporated herein by reference.

### BACKGROUND OF THE INVENTION

### Technical Field

The present invention relates to a charging device, an image forming apparatus, and a cleaning method.

### Description of Related Art

A charging device used to charge a photoconductor in an electrophotographic image forming apparatus has a charging wire for discharging.

The charging wire needs to be cleaned from time to time to prevent image degradation. There are two cleaning methods: automatic cleaning by a cleaning device provided in the charging device, and manual cleaning by a user.

The automatic cleaning is periodically and automatically performed, and thus has an advantage that the user does not forget to perform cleaning. However, there are disadvantages that only uniform cleaning can be performed, and it is not possible to carefully clean only particularly dirty areas.

On the other hand, the manual cleaning is advantageous in that, for example, a particularly dirty areas can be carefully cleaned. However, there is a disadvantage that the cleaning is likely to be forgotten.

Therefore, it is desirable to use both automatic cleaning and manual cleaning for cleaning the charging wire because the disadvantages of the automatic cleaning and the manual cleaning can be cancelled out.

JP2013083807A discloses a technology that enables manual cleaning using a cleaning pad 532 to be used for automatic cleaning. According to such technology, there is no need to prepare a separate cleaning tool for manual cleaning. Also, the user does not worry about where to insert the cleaning tool into the charging device, and it is convenient because both automatic and manual cleaning can be performed.

### SUMMARY OF THE INVENTION

To perform manual cleaning using the technology disclosed in JP2013083807A, first, the cleaning pad 532 is located at a home position P. In this state, a handle 535 is manually operated to manually move the conveying screw 531. Then, a driven-side shaft coupling 533 is separated from a driving-side shaft coupling 58. At this time, a tip portion 534A of an engaging member 534 provided on the cleaning pad 532 is engaged with the driven-side shaft coupling 533, so that the cleaning pad 532 can be manually operated by the handle 535 for manual cleaning. Accordingly, switching from the automatic cleaning mode to the manual cleaning mode requires a certain amount of time and effort.

After the manual cleaning is completed, the cleaning pad 532 must be electrically returned to the home position P. Therefore, unless the power of the image forming apparatus is kept on, the mode cannot be switched to the manual cleaning mode.

In the JP2013-083807A technology, preparations must be made in advance in order to perform the manual cleaning, and the manual cleaning process is complicated.

In view of the above, an object of the present invention is to provide a charging device, an image forming apparatus, and a cleaning method that allow for switching from an automatic cleaning mode to a manual cleaning mode even when the power is off, and that do not require complicated switching.

To achieve at least one of the abovementioned objects, according to an aspect of the present invention, a charging device reflecting one aspect of the present invention comprises: a discharging member configured to carry out discharge to charge a photoconductor; a cleaning member configured to clean the discharging member; a conveying screw in the shape of a shaft and engaged with the cleaning member by screw action, the conveying screw configured to move the cleaning member in a longitudinal direction of the discharging member and in an axial direction of the conveying screw when it is rotated; a driving device located on a rear side of a main body and configured to rotationally drive the conveying screw; a detachable member that allows the driving device and the conveying screw to be attached to and detached from each other in a longitudinal direction of the conveying screw on a driving device side; a shaft support member configured to rotationally support the conveying screw; and a handle provided on an end portion side opposite to the driving device side in the longitudinal direction of the conveying screw, the handle configured to allow the cleaning member to be manually moved along the discharging member after the driving device and the conveying screw are disengaged by the detachable member. The cleaning member has a home position at the driving device side in the longitudinal direction of the conveying screw.

To achieve at least one of the abovementioned objects, according to an aspect of the present invention, an image forming apparatus reflecting one aspect of the present invention comprises: a photoconductor; the above-described charging device configured to charge the photoconductor; an exposure device configured to form an electrostatic latent image on the photoconductor; and a developing device configured to develop the electrostatic latent image with toner.

Further, to achieve at least one of the abovementioned objects, according to an aspect of the present invention, there is provided a method for cleaning a charging device reflecting one aspect of the present invention. The method for cleaning a charging device that includes: a discharging member configured to carry out discharge to charge a photoconductor; a cleaning member configured to clean the discharging member; a conveying screw in the shape of a shaft and configured to move the cleaning member in a longitudinal direction of the discharging member and in an axial direction of the conveying screw when it is rotated; a driving device configured to rotationally drive the conveying screw; a detachable member that allows the driving device and the conveying screw to be attached to and detached from each other in a longitudinal direction of the conveying screw on a driving device side; a shaft support member configured to rotationally support the conveying screw; and a handle provided on an end portion side opposite to the driving device side in the longitudinal direction of the conveying screw, the handle configured to allow the cleaning member to be manually moved along the discharging member after the driving device and the conveying screw are disengaged by the detachable member, wherein the cleaning member has a home position at the driving device side in the longitudinal direction of the conveying screw, comprises the steps of: operating the conveying screw with the handle to disengage or engage the conveying screw and the driving device through the detachable member, and manually moving the cleaning member to clean the discharging member with the cleaning member.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a perspective view illustrating the overall external appearance of an image forming apparatus according to one embodiment of the present invention.

FIG. 2 is a perspective view illustrating an image forming apparatus main body included in the image forming apparatus according to the embodiment of the present invention.

FIG. 3 is a longitudinal cross-sectional view illustrating a housing of a charging device according to the embodiment of the present invention.

FIG. 4 is a perspective view illustrating a driving mechanism for a cleaning member in the charging device according to the embodiment of the present invention.

FIG. 5 is an enlarged perspective view illustrating a peripheral portion of a detachable member and a connecting member in the charging device according to the embodiment of the present invention.

FIG. 6 is an enlarged perspective view illustrating a state in which engagement between a male member and a female member of the detachable member in the charging device according to the embodiment of the present invention is released.

FIG. 7 is an enlarged perspective view illustrating a state in which engagement between a male member and a female member of the connecting member in the charging device according to the embodiment of the present invention is released.

FIG. 8 is a longitudinal cross-sectional view illustrating a state in which the detachable member and the connecting member in the charging device according to the embodiment of the present invention are connected to each other.

FIG. 9 is a longitudinal cross-sectional view illustrating a cleaning member in the charging device according to the embodiment of the present invention.

FIG. 10 is a longitudinal cross-sectional view illustrating a handle in the charging device according to the embodiment of the present invention.

FIG. 11 is a lateral cross-sectional view illustrating the periphery of the cleaning member in the vicinity of the home position in the charging device according to the embodiment of the present invention.

FIG. 12 is a lateral cross-sectional view illustrating the periphery of the cleaning member in the vicinity of the home position in the charging device according to the embodiment of the present invention.

FIG. 13 is a lateral cross-sectional view illustrating the periphery of the cleaning member in the vicinity of the home position in the charging device according to the embodiment of the present invention.

FIG. 14 is a lateral cross-sectional view illustrating the periphery of the cleaning member in the vicinity of the home position in the charging device according to the embodiment of the present invention.

FIG. 15 is a lateral cross-sectional view illustrating the periphery of the cleaning member in the vicinity of the home position in the charging device according to the embodiment of the present invention.

FIG. 16 is a lateral cross-sectional view illustrating the periphery of the cleaning member in the vicinity of the home position in the charging device according to the embodiment of the present invention.

FIG. 17 is a lateral cross-sectional view illustrating the periphery of the cleaning member in the vicinity of the home position in the charging device according to the embodiment of the present invention.

FIG. 18 is a lateral cross-sectional view illustrating the periphery of the cleaning member in the vicinity of the home position in the charging device according to the embodiment of the present invention.

FIG. 19 is a perspective view illustrating the inside of the housing of the image forming apparatus according to the embodiment of the present invention when a cover is opened.

FIG. 20 is a perspective view illustrating the relationship between the cover and the handle in the image forming apparatus according to the embodiment of the present invention.

FIG. 21 is a cross-sectional view illustrating the relationship between the cover and the handle in the image forming apparatus according to the embodiment of the present invention.

FIG. 22 is a block diagram showing a control system of the charging device according to the embodiment of the present invention.

### DETAILED DESCRIPTION

Hereinafter, one or more embodiments of the present invention will be described with reference to the drawings. However, the scope of the invention is not limited to the disclosed embodiments.

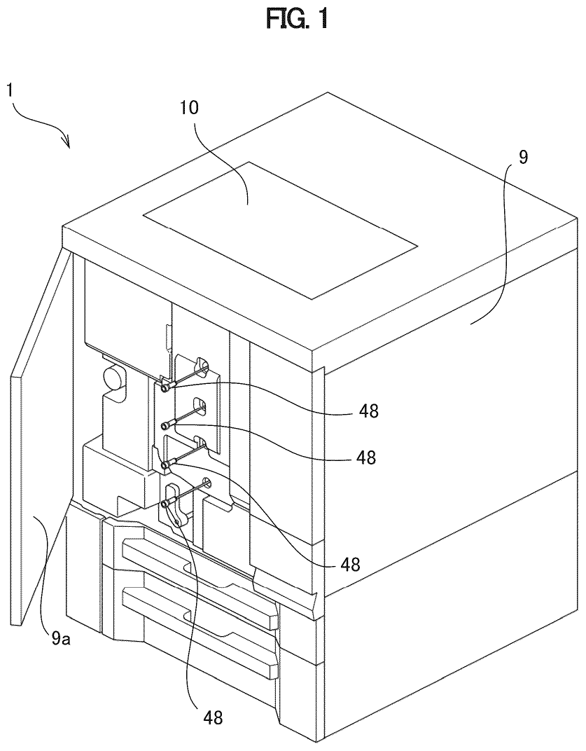

FIG. 1 is a perspective view illustrating the overall external appearance of an image forming apparatus according to this embodiment. This image forming apparatus 1 is an apparatus that forms an image on a print medium such as a sheet by an electrophotographic method. The image forming apparatus 1 includes a housing 9. The housing 9 has a cover 9a on the front side. The cover 9a can be opened and closed freely. A contact glass 10 is provided at an upper portion of the housing 9.

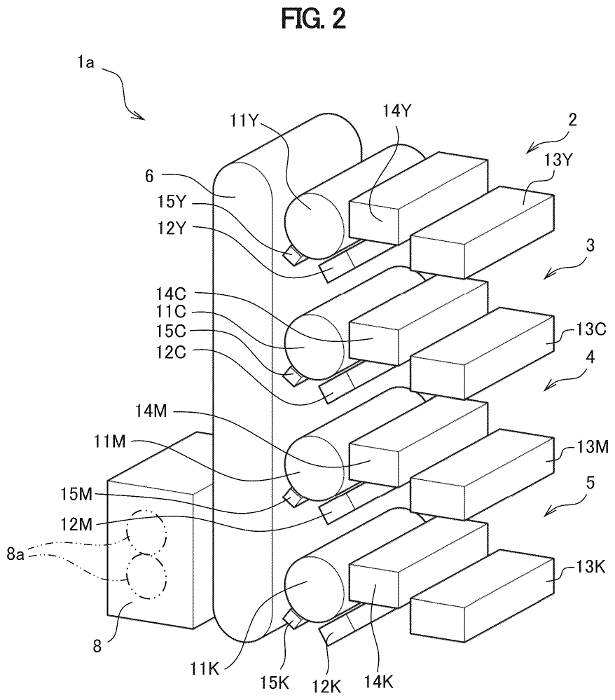

FIG. 2 is a perspective view illustrating an image forming apparatus main body included in the image forming apparatus according to this embodiment. An image forming apparatus main body 1a is stored in the housing 9. The image forming apparatus main body 1a includes, for example, four image forming sections 2 to 5 arranged in a vertical row, a first transfer belt (transfer device) 6, and a fixing device 8.

The image forming sections 2 to 5 are devices that form toner images in different colors (e.g., yellow (Y), cyan (C), magenta (M), and black (K)) on photoconductors (photosensitive drums) 11Y, 11C, 11M, 11K, respectively.

In this embodiment, the image forming section 2 is a device that forms a yellow (Y) toner image on the photoconductor 11Y. The image forming section 3 is a device that forms a cyan (C) toner image on the photoconductor 11C. The image forming section 4 is a device that forms a magenta (M) toner image on the photoconductor 11M. The image forming section 5 is a device that forms a black (K) toner image on the photoconductor 11K. Note that in this embodiment, four image forming sections can form images with four colors of toner, but five or more colors of toner or only one color of toner may be used.

The image forming section 2 includes, around the photoconductor 11Y, a charging device 12Y to charge the surface of the photoconductor 11Y, an exposure device 13Y to optically write an electrostatic latent image on the surface of the photoconductor 11Y, a developing device 14Y to develop the electrostatic latent image on the photoconductor 11Y with yellow (Y) toner, and a charge remover 15Y to remove the charge from the surface of the photoconductor 11Y.

The image forming section 3 includes, around the photoconductor 11C, a charging device 12C to charge the surface of the photoconductor 11C, an exposure device 13C to optically write an electrostatic latent image on the surface of the photoconductor 11C, a developing device 14C to develop the electrostatic latent image on the photoconductor 11C with cyan (C) toner, and a charge remover 15C to remove the charge from the surface of the photoconductor 11C.

The image forming section 4 includes, around the photoconductor 11M, a charging device 12M to charge the surface of the photoconductor 11M, an exposure device 13M to optically write an electrostatic latent image on the surface of the photoconductor 11M, a developing device 14M to develop the electrostatic latent image on the photoconductor 11M with magenta (M) toner, and a charge remover 15M to remove the charge from the surface of the photoconductor 11M.

The image forming section 5 includes, around the photoconductor 11K, a charging device 12K to charge the surface of the photoconductor 11K, an exposure device 13K to optically write an electrostatic latent image on the surface of the photoconductor 11K, a developing device 14K to develop the electrostatic latent image on the photoconductor 11K with black (K) toner, and a charge remover 15K to remove the charge from the surface of the photoconductor 11K.

In the case of comprehensively describing the respective parts without distinguishing toner colors to be used, the parts are merely shown with reference numerals only (for example, like the photoconductor 11).

The first transfer belt 6 is a belt conveyor-like device, and is arranged along the respective photoconductors 11Y, 11M, 11C, 11K of the image forming sections 2 to 5 with the vertical direction as the longitudinal direction in this embodiment. The toner images formed on the photoconductors 11Y, 11M, 11C, 11K are transferred to the first transfer belt 6 such that the toner images are superimposed on each other. The toner image, in which the toners of the respective colors are superimposed one on another, is transferred by a second transfer device (transfer device), not shown in the drawings, onto a sheet (not shown) that may be a flat sheet or continuous sheet. The sheet is supplied from a sheet feed section 71. The sheet on which the toner image have been transferred is conveyed to a fixing device 8, and the fixing device 8 fixes the toner image on the sheet, so that a color image is formed on the sheet.

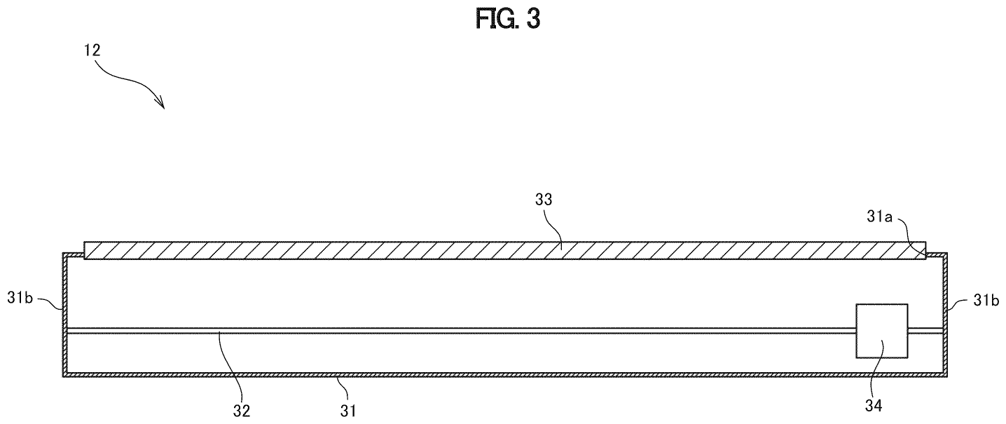

FIG. 3 is a longitudinal cross-sectional view illustrating a housing of the charging device according to this embodiment. The charging device 12 is a scorotron charging-type charger. The charging device 12 includes an elongated housing 31. An upper part of the housing 31 in FIG. 3 forms an opening 31a.

A metal charging wire (discharging member) 32 extending from one end side to the other end side in the longitudinal direction of the housing 31 is provided inside the housing 31. The charging wire 32 is energized through a predetermined electrical system for discharge.

A mesh-like metal grid 33 (charging grid) is attached to the opening 31a of the housing 31. The grid 33 makes the discharge generated from the charging wire 32 more uniform than in a case where the grid 33 does not exist. The grid 33 charges the surface of the photoconductor 11 (upper side in FIG. 3) as uniformly as possible.

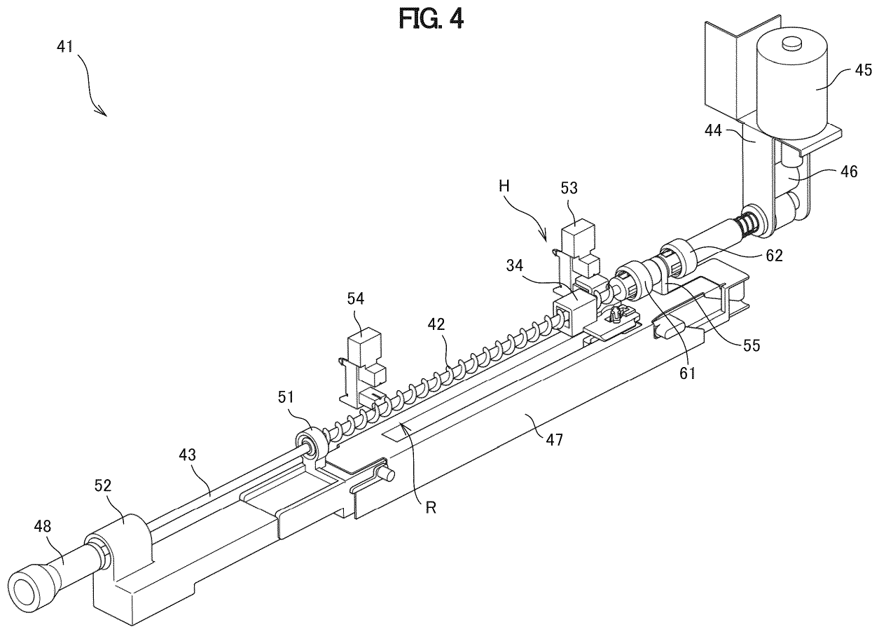

A cleaning member 34 is attached to the charging wire 32. The cleaning member 34 is driven by a motor 45 (see FIG. 4) as a driving source and moves along the longitudinal direction of the charging wire 32 via a driving device 44 (see FIG. 4) to clean the charging wire 32.

Next, a driving mechanism for the cleaning member 34 in the charging device 12 will be described in detail.

FIG. 4 is a perspective view illustrating a driving mechanism 41 for the cleaning member 34. The driving mechanism 41 enables both automatic cleaning and manual cleaning of the charging wire 32 using the cleaning member 34.

The driving mechanism 41 includes a conveying screw 42. The conveying screw 42 is engaged with (meshes with) the cleaning member 34 by screw action, and rotates to move the cleaning member 34 in the longitudinal direction of the charging wire 32 and in the axial direction of the conveying screw 42. For the sake of convenience, the conveying screw 42 shown in FIG. 4 is illustrated to be shorter than its actual size. A shaft-like member 43 on which no screw is formed is connected to one end of the conveying screw 42. The range of the conveying screw 42 from end to end in the longitudinal direction thereof substantially corresponds to the range of the charging wire 32 from end to end in the longitudinal direction. In other words, by the rotation of the conveying screw 42, the cleaning member 34 moves in the axial direction of the conveying screw 42 over substantially the entire region from one end to the other end with respect to the longitudinal direction of the charging wire 32.

The driving device 44 includes a motor 45 serving as a drive source and a connecting mechanism 46. The driving device 44 is connected to the conveying screw 42 on the connecting mechanism 46 side. Thus, the conveying screw 42 is rotationally driven by the driving device 44. The motor 45 can rotate in forward and reverse directions. The driving device 44 is located on the rear side of the image forming apparatus main body (main body of the image forming apparatus 1) (that is the back side relative to a closed position of the cover 9a on the housing 9 when an operator stands in front of the cover 9a in FIG. 1).

The conveying screw 42 and the shaft-like member 43 are rotatably supported by shaft support members 51, 52, 55 that are supported on a pedestal 47.

Sensors 53, 54, each formed of an optical sensor or the like, are respectively disposed at a home position H of the cleaning member 34 and at a return position R of the cleaning member 34, where the reciprocating movement of the cleaning member 34 is switched. The sensors 53, 54 detect that the cleaning member 34 has reached the home position H and the return position R, respectively. FIG. 4 illustrates a state in which the cleaning member 34 is located at the home position H. As is obvious from FIG. 4, the home position H of the cleaning member 34 is on the driving device 44 side in the longitudinal direction of the conveying screw 42.

A handle 48 is provided on an end portion side (on one end portion of the shaft-like member 43) opposite to the driving device 44 side in the longitudinal direction of the conveying screw 42. The handle 48 is configured to allow the cleaning member 34 to be manually moved along the charging wire 32 (see FIG. 2) after the driving device 44 and the conveying screw 42 are disengaged by the detachable member 61.

The conveying screw 42 and the driving device 44 are connected to each other by a connecting member 62 at a position closer to the driving device 44 than the shaft support member 55. When the charging device 12 is attached to a predetermined position around the photoconductor 11, the driving device 44 and the conveying screw 42 are connected by the connecting member 62.

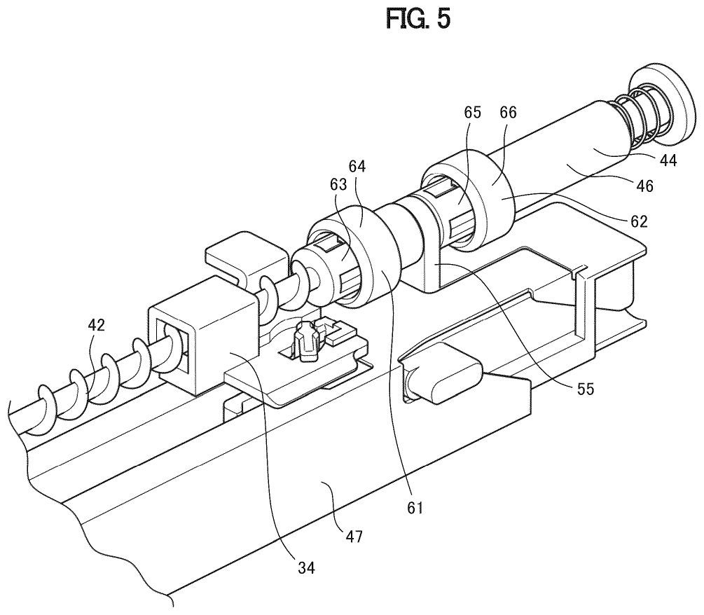

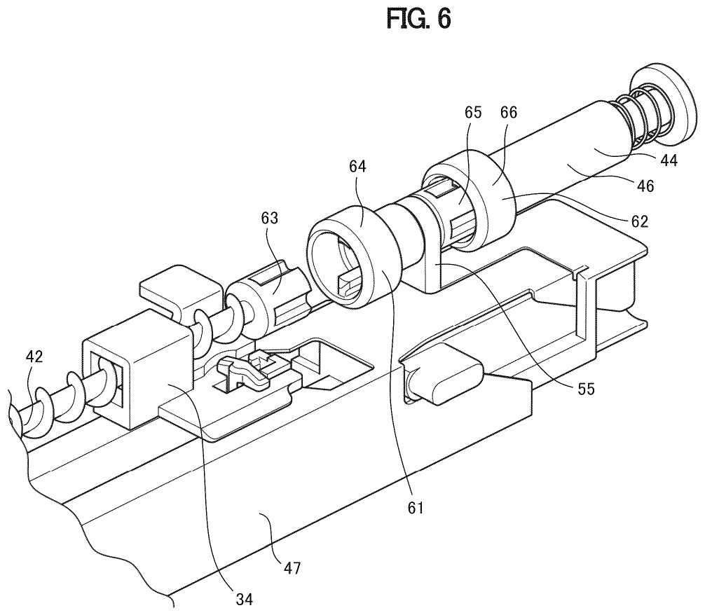

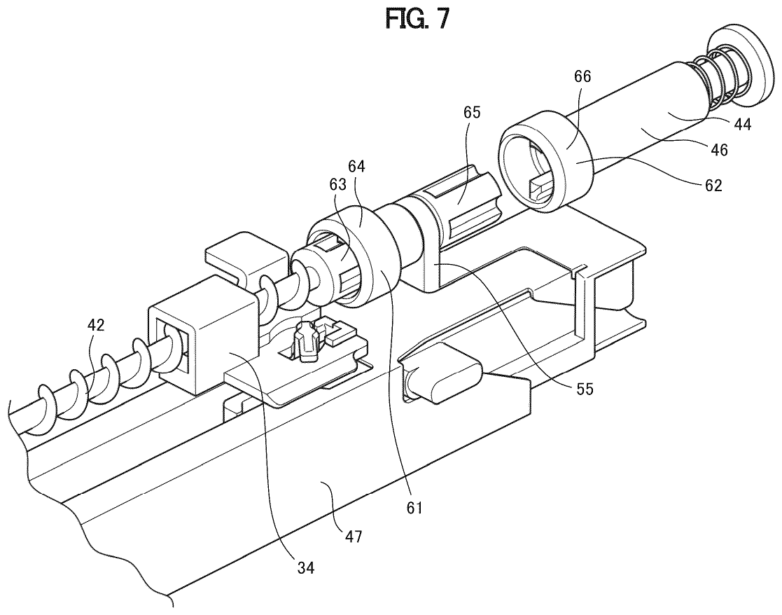

FIG. 5 is an enlarged perspective view illustrating a peripheral portion of the detachable member and the connecting member. The detachable member 61 detachably engages a male member 63 on the side of the conveying screw 42 with a female member 64 on the side of the driving device 44. FIG. 6 is an enlarged perspective view illustrating a state in which engagement between the male member and the female member of the detachable member is released. Returning to FIG. 5, the connecting member 62 detachably engages the male member 65 on the side of the conveying screw 42 and the female member 66 on the side of the driving device 44. FIG. 7 is an enlarged perspective view illustrating a state in which engagement between a male member and a female member of the connecting member is released.

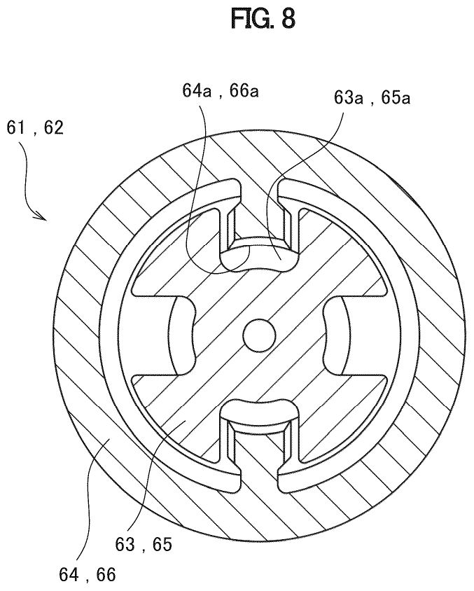

The structure for connecting the detachable member 61 and the connecting member 62 is the same as the structure described above. FIG. 8 is a longitudinal cross-sectional view illustrating a state in which the detachable member and the connecting member are connected to each other. To be more specific, the male members 63, 65 and the female member 64, 66 are both formed in a protrusive-recessed shape in the axial circumferential direction, and recessed portions 63a, 65a of the male members 63, 65 and protrusive portions 64a, 66a of the female members 64, 66 are engaged with each other, so that the conveying screw 42 rotates following the rotational driving operation on the side of the driving device 44.

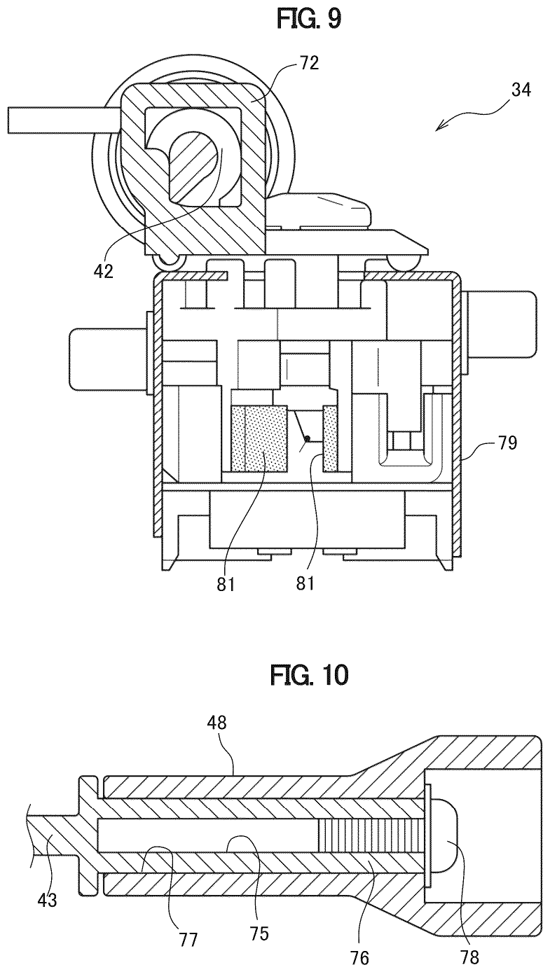

FIG. 9 is a longitudinal cross-sectional view of the cleaning member. The cleaning member 34 includes a body portion 79, and a shaft support portion 72 provided at an upper part of the body portion 79. The shaft support portion 72 is a portion that is engaged with (meshes with) the conveying screw 42 by screw action. The shaft support portion 72 of the cleaning member 34 is provided so as to cover the entire circumference of the conveying screw 42 in its axial circumferential direction.

FIG. 10 is a longitudinal cross-sectional view of the handle. The handle 48 is attached to the conveying screw 42 such that the handle 48 is rotatable relative to the conveying screw 42 in the axial circumferential direction of the conveying screw 42. To be more specific, an end portion of the shaft-like member 43 has an attachment portion 76. The attachment portion 76 has a larger diameter than the shaft-like member 43, and a screw hole 75 is formed inside the attachment portion 76. A hollow portion 77 is formed inside the handle 48. The attachment portion 76 is inserted into the hollow portion 77, and the attachment portion 76 and the handle 48 are engaged by a screw 78. Because the outer circumference of the attachment portion 76 is cylindrical and the inner circumference of the hollow portion 77 is circular, even if the handle 48 is rotated in the circumferential direction, the attachment portion 76 is immovable and only the handle 48 rotates.

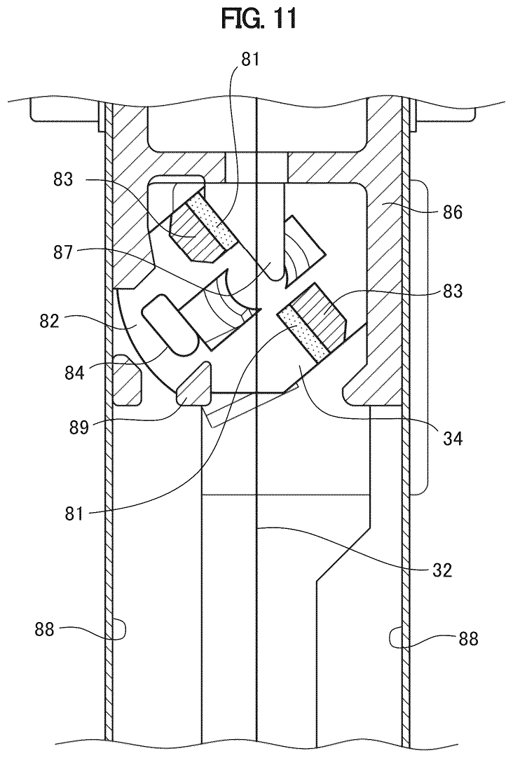

FIGS. 11 to 18 are lateral cross-sectional views illustrating the periphery of the cleaning member in the vicinity of the home position. Referring to FIG. 11, the cleaning member 34 in this embodiment has two cleaning pads 81. The cleaning pads 81 are pads that can contact the charging wire 32 to clean the charging wire 32. The cleaning pads 81 are attached to side portions of support members 83. The support members 83 are raised from a base table 82 that is provided in the body portion 79 (see FIG. 9) of the cleaning member 34. The two cleaning pads 81 face in opposite directions. An abutting portion 84 is also raised from the base table 82.

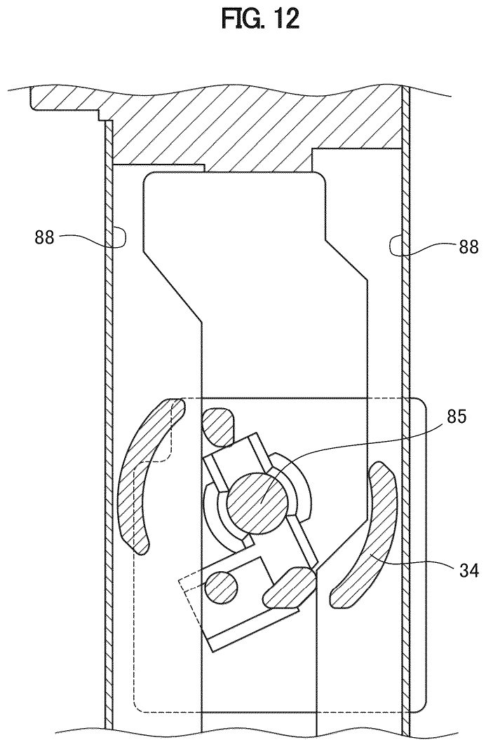

As shown in FIG. 12, a rotation shaft 85 is provided in the body portion 79 (see FIG. 9). The rotation shaft 85 rotatably supports the base table 82 at a position above the base table 82 shown in FIG. 11. On both sides of the cleaning member 34, guide members 88 extend to guide the movement of the cleaning member 34.

Returning to FIG. 11, the cleaning member 34 is located at the home position H (see FIG. 4) in FIG. 11. Hereinafter, the home position H will be referenced using FIG. 4 and FIG. 11. In this home position H, a driving member 86 is disposed. The driving member 86 has an abutting portion 87 on the far side as seen from the cleaning member 34 and an abutting portion 89 near the abutting portion 84 in FIG. 11.

As shown in FIG. 11, when the cleaning member 34 is located at the home position H, one of the two cleaning pads 81 is in contact with the abutting portion 87, so that the two cleaning pads 81 are separated from the charging wire 32.

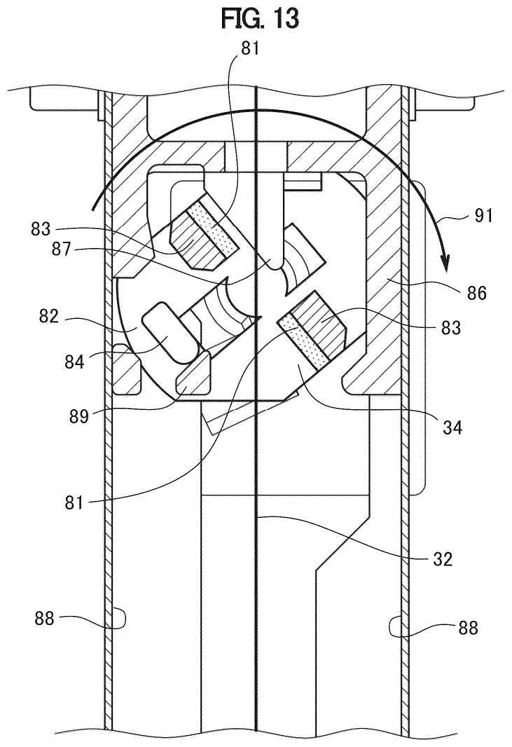

FIG. 13 illustrates a state in which the cleaning member 34 has moved a little (downward in FIG. 13) from the home position H shown in FIG. 11. When the state in which one of the cleaning pads 81 is in contact with the abutting portion 87 (the state shown in FIG. 11) is released, a gap is generated between the cleaning pad 81 and the abutting portion 87. After the abutting portion 84 comes into contact with the abutting portion 89, the cleaning member 34 starts to rotate in the direction of the arrow 91 about the rotation shaft 85.

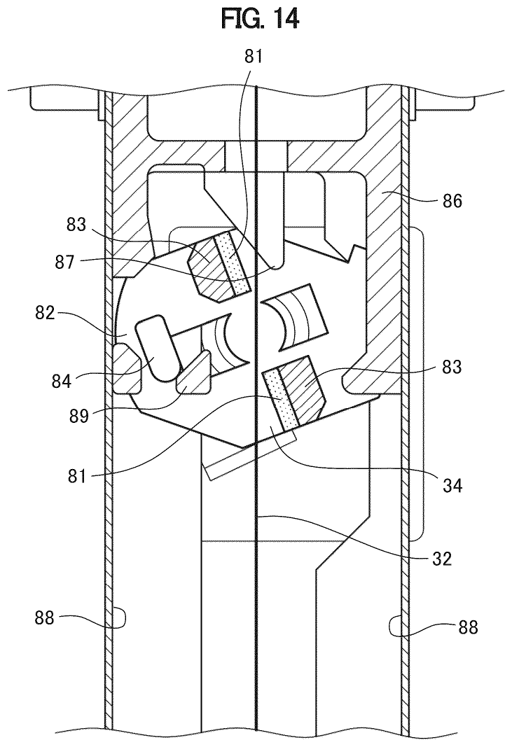

FIG. 14 illustrates the state in which the cleaning member 34 has moved further (downward in FIG. 14) from the state shown in FIG. 13. Here, the contact between the abutting portion 84 and abutting portion 89 further rotates the cleaning member 34, and the two cleaning pads 81 approach the charging wire 32 from both the left and right sides.

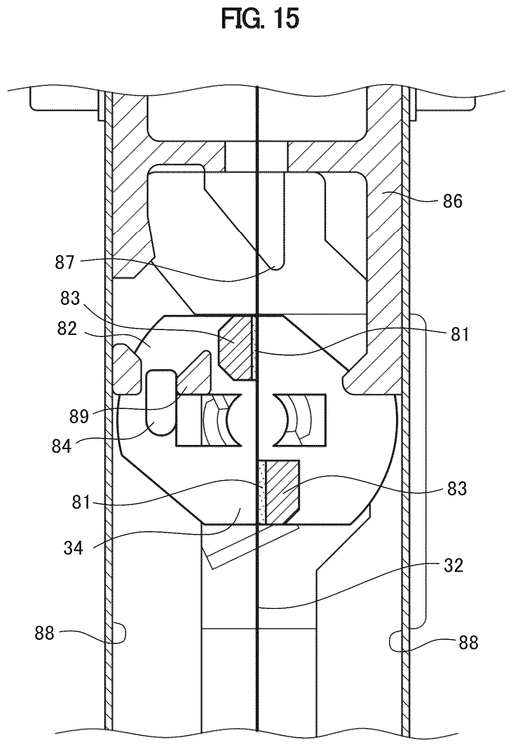

FIG. 15 illustrates the state in which the cleaning member 34 has moved further (downward in FIG. 15) from the state shown in FIG. 14. The abutting portion 84 passes aside the abutting portion 89, and the cleaning member 34 is ready to move from the home position H toward the return position R (see FIG. 4). Hereinafter, the state in which the cleaning member 34 is ready to move from the home position H toward the return position R will be referenced using FIGS. 4 and 15. At this time, the two cleaning pads 81 come into contact with the charging wire 32, sandwiching the charging wire 32 from the left and right sides, respectively, and allowing for the cleaning of the charging wire 32. In this state, the cleaning member 34 can move while being guided by the guide members 88.

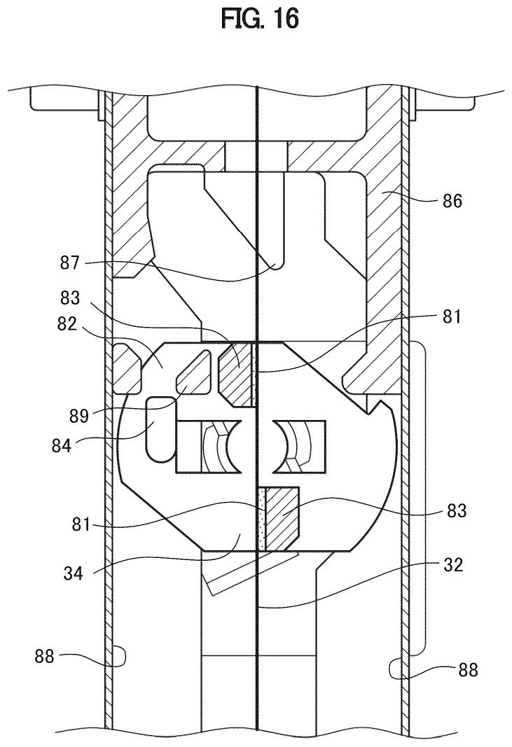

In this state, the cleaning member 34 moves forward (forward movement) and returns (backward movement) at the return position R. FIG. 16 illustrates the state in which the cleaning member 34 having returned from the return position R approaches the home position H.

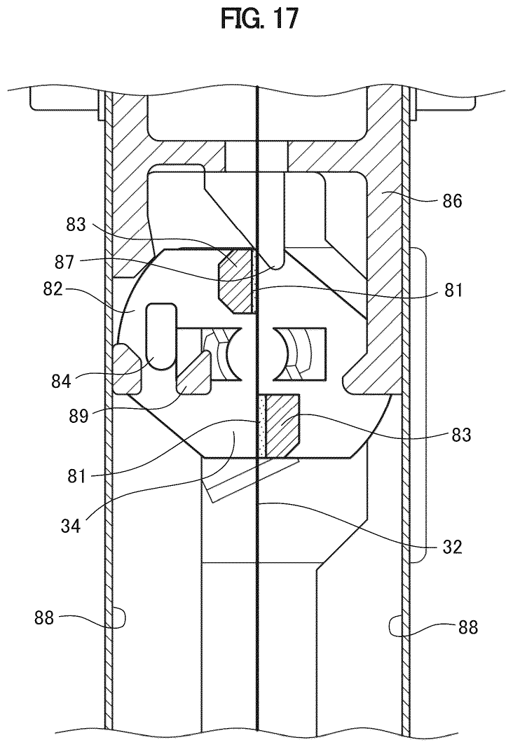

As seen in FIG. 17, when the cleaning member 34 moves further (upward in FIG. 17) from the state shown in FIG. 16, the abutting portion 84 passes aside the abutting portion 89, and the leading cleaning pad 81 comes into contact with the abutting portion 87.

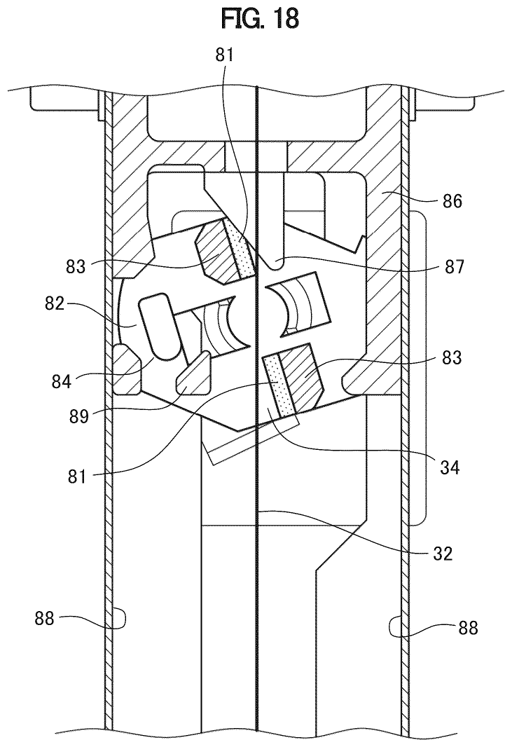

As shown in FIG. 18, when the cleaning member 34 moves further (upward in FIG. 18) from the state shown in FIG. 17, the cleaning member 34 approaches the home position H. In this state, the cleaning pad 81 contacts the abutting portion 87, and the base table 82 rotates around the rotation shaft 85 (see FIG. 12) (in the opposite direction of the arrow 91 in FIG. 13), causing the two cleaning pads 81 to start separating from the charging wire 32. Then, as seen in FIG. 10, when the cleaning member 34 returns fully to the home position H, the two cleaning pads 81 are completely separated from the charging wire 32 and the cleaning member 34 stops at the home position H.

As described above, when the cleaning member 34 is located at the home position H, the cleaning pads 81 can be separated from the charging wire 32 by the operating mechanism including the rotation shaft 85, the driving member 86, and the abutting portion 84. Further, when the cleaning member 34 moves from the home position H, the operating mechanism can cause the cleaning pads 81 to contact the charging wire 32.

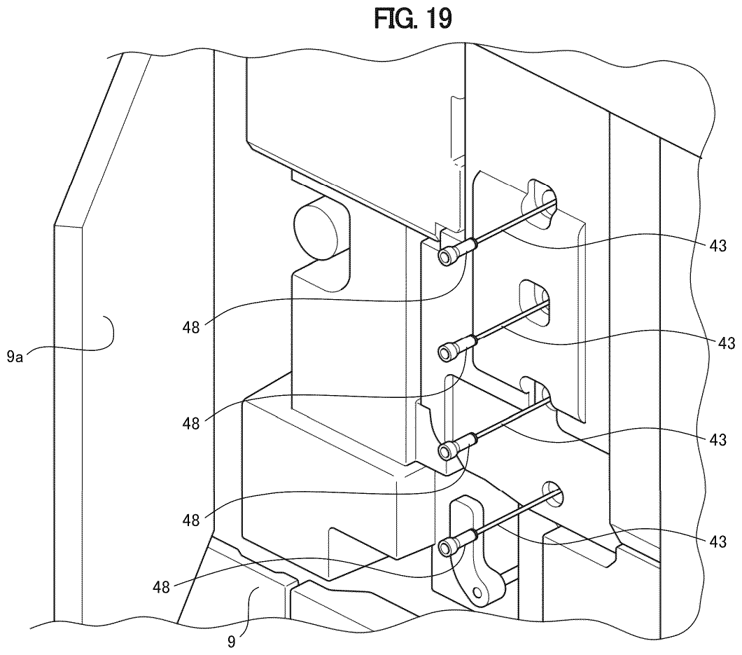

FIG. 19 is a perspective view illustrating the inside of the housing when the cover is opened. As seen in FIG. 1, the cover 9a is provided on the front side of the housing 9 of the image forming apparatus 1. Further, as seen in FIG. 19, when the cover 9a is opened, the handles 48 corresponding to the charging devices 12Y, 12M, 12C, 12K are exposed inside the housing 9.

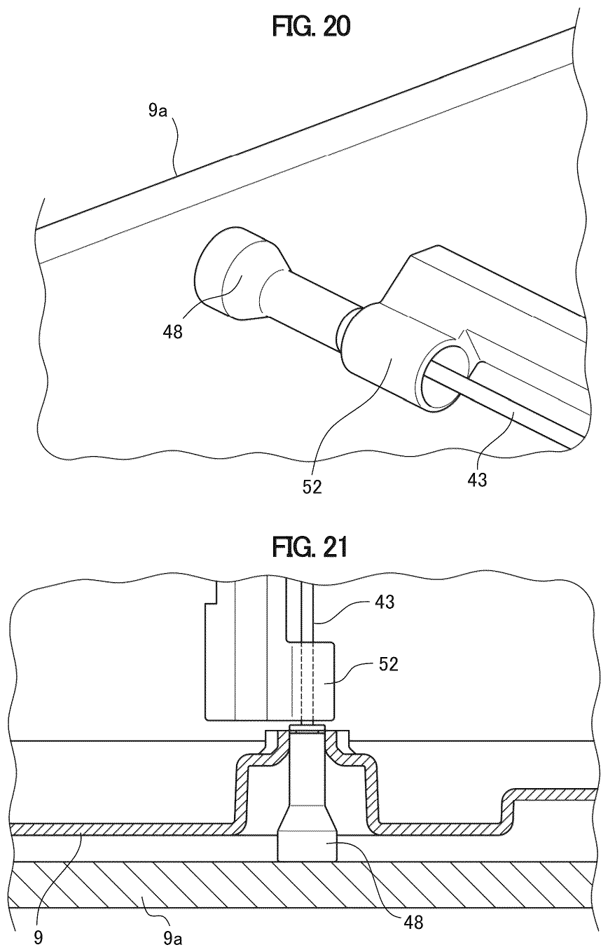

FIG. 20 is a perspective view illustrating the relationship between the cover and the handle, and FIG. 21 is a cross-sectional view illustrating the relationship between the cover and the handle. As described later, after the cleaning member 34 in the home position H is used for the manual cleaning by operating the handle 48 (after the cleaning member 34 is pulled out from the home position H by operating the handle 48), the cover 9a is closed. Closing the cover 9a can press the handle 48, causing the handle 48 to be pushed into the housing 9. Thus, the cleaning member 34 returns to the home position H.

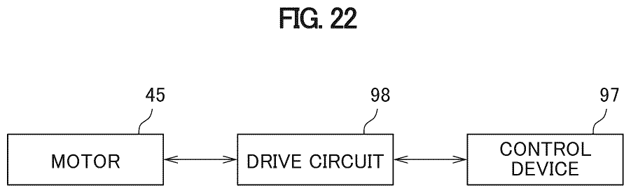

FIG. 22 is a schematic diagram showing a control system of the charging device 12. A control device 97 is formed of a microcomputer or the like that controls the charging device 12. The motor 45 of the charging device 12 is driven via a drive circuit 98 by the control signal outputted from the control device 97. Other controls of the charging device 12 are performed by the control device 97.

Next, advantageous effects of this embodiment will be described below.

The automatic cleaning can be automatically performed at a predetermined timing. For example, the automatic cleaning is performed every time the number of images formed by the image forming apparatus 1 reaches a predetermined number. In the automatic cleaning, from the state illustrated in FIG. 4, the cleaning member 34 can be driven under the control of the control device 97 to clean the charging wire 32 with the cleaning member 34. The cleaning member 34 moves forward from the home position H toward the return position R, and when reaching the return position R, the cleaning member 34 moves backward to return to the home position H. Switching between the forward movement and the backward movement is enabled by switching between forward and reverse operations of the motor 45. The control device 97 detects that the cleaning member 34 has reached the home position H and the return position R using the sensors 53, 54. In one automatic cleaning operation, the cleaning member 34 may be reciprocated once or a plurality of times. When the automatic cleaning is completed, the cleaning member 34 returns to the home position H. This is because the home position H of the cleaning member 34 is a position where the cleaning member 34 does not interfere with the discharge of the charging device 12 during image formation.

In the technology disclosed in JP2013083807A, when the manual cleaning is performed, the home position P of the cleaning pad 532 is far from the driving side of the cleaning pad 532. Therefore, the conveying screw 531 is manually operated to disengage the driven-side shaft coupling 533 from the driving-side shaft coupling 58. Then, the tip portion 534A of the engaging member 534 provided on the cleaning pad 532 is engaged with the driven-side shaft coupling 533. This makes it possible to manually operate the cleaning pad 532 by the handle 535 for the manual cleaning.

If an attempt is made to move the cleaning pad 532 by a manual operation without performing such an operation, the driven-side shaft coupling 533 abuts against the driving-side shaft coupling 58. Therefore, because the cleaning pad 532 cannot be moved from the home position P toward the return position R, the manual cleaning cannot be performed.

Further, according to the technology disclosed in JP2013083807A, the image forming apparatus must be kept on in order to electrically return the cleaning pad 532 to the home position P after the manual cleaning is completed.

In contrast, the image forming apparatus 1 according to this embodiment is configured such that the home position H of the cleaning member 34 is on the driving device 44 side in the longitudinal direction of the conveying screw 42 as shown in FIG. 4. For this reason, when the manual cleaning is performed, the male member 63 and the female member 64 of the detachable member 61 are disengaged from each other by pulling the handle 48 from the state shown in FIG. 4 (FIG. 6). At this time, the shaft support member 55 serves as a stopper, and the connecting member 62 remains connected to the driving side. Operating the handle 48 causes the conveying screw 42 and the like to move in the axial direction while being guided by the shaft support members 51, 52, thereby enabling movement of the cleaning member 34. Therefore, the charging wire 32 can be manually cleaned by the cleaning member 34. Accordingly, the manual cleaning allows for careful cleaning of particularly dirty areas of the charging wire 32 by specifically targeting those areas. After the manual cleaning is completed, the cleaning member 34 can be easily returned to the home position H by pushing the handle 48 into the housing 9. Because the male member 63 and the female member 64 of the detachable member 61 can be re-engaged, there is no problem in the subsequent automatic cleaning.

As described above in this embodiment, the manual cleaning does not require a complicated manual operation such as disclosed in JP2013083807A. Further, since the cleaning member 34 can be returned to the home position H by a simple manual operation after the completion of the manual cleaning, the manual cleaning can be performed even if the image forming apparatus 1 is turned off.

Therefore, according to this embodiment, it is possible to provide the charging device 12, the image forming apparatus 1, and the cleaning method that can perform not only the automatic cleaning but also the manual cleaning with simple means.

In other words, according to this embodiment, it is possible to provide the charging device 12, the image forming apparatus 1, and the cleaning method that allow for switching from the automatic cleaning mode to the manual cleaning mode even when the power source is turned off and that do not require complicated switching.

The cleaning member 34 is provided so as to cover the entire circumference of the conveying screw 42 in the axial circumferential direction (see FIG. 9). This can prevent the cleaning member 34 from falling off from the conveying screw 42.

The handle 48 is attached to the conveying screw 42 side (to the shaft-like member 43) so as to be rotatable in the axial circumferential direction of the conveying screw 42. This can prevent the cleaning member 34 from tilting, even if the handle 48 rotates in the axial circumferential direction while the handle 48 is being operated.

As described above with reference to FIGS. 11 to 18, the cleaning pads 81 are separated from the charging wire 32 when the cleaning member 34 is located at the home position H, and the cleaning pads 81 are brought into contact with the charging wire 32 when the cleaning member 34 is moved from the home position H. Therefore, since the cleaning pads 81 are separated from the charging wire 32 when the cleaning member 34 is in the home position H, the cleaning pads 81 or the like are not damaged by the discharge even when the discharge is performed by the charging wire 32.

When the cleaning pads 81 are brought into contact with the charging wire 32, for example, two cleaning pads 81 sandwich the charging wire 32 to clean the charging wire 32 (see FIG. 15). Therefore, the cleaning of the charging wire 32 can be effectively performed.

The motor 45 is rotatable in forward and reverse directions, so that the cleaning member 34 can be reciprocated during the automatic cleaning.

The image forming apparatus 1 is configured such that the handle 48 is exposed to the inside of the housing 9 when the cover 9a is opened (FIG. 19), so that the manual cleaning can be easily performed.

Further, when the cover 9a is closed, the handle 48 is pressed by the cover 9a and the cleaning member 34 returns to the home position H (see FIG. 21). Therefore, the cleaning member 34 can be easily returned to the home position H after the manual cleaning is performed.

Note that the embodiment described above is merely one embodiment of the present invention and does not limit the present invention.

For example, the sensors 53, 54 may not be provided. Alternatively, the control device 97 (detecting device) may detect whether the cleaning member 34 is located at the home position H or the return position R by detecting an overcurrent in the motor 45 that is caused by physical contact of the cleaning member 34.

This configuration can eliminate the need to provide the sensors 53, 54, so that the manufacturing cost of the image forming apparatus 1 can be reduced.

Although embodiments of the present invention have been described and illustrated in detail, the disclosed embodiments are made for purposes of illustration and example only and not limitation. The scope of the present invention should be interpreted by terms of the appended claims.

What is claimed is:

1. A charging device comprising:
a discharging member configured to carry out discharge to charge a photoconductor;
a cleaning member configured to clean the discharging member;
a conveying screw in the shape of a shaft and engaged with the cleaning member by screw action, the conveying screw configured to move the cleaning member in a longitudinal direction of the discharging member and in an axial direction of the conveying screw when it is rotated;
a driving device located on a rear side of a main body and configured to rotationally drive the conveying screw;
a detachable member that allows the driving device and the conveying screw to be attached to and detached from each other in a longitudinal direction of the conveying screw on a driving device side;
a shaft support member configured to rotationally support the conveying screw; and
a handle provided on an end portion side opposite to the driving device side in the longitudinal direction of the conveying screw, the handle configured to allow the cleaning member to be manually moved along the discharging member after the driving device and the conveying screw are disengaged by the detachable member,
wherein the cleaning member has a home position at the driving device side in the longitudinal direction of the conveying screw.

2. The charging device according to claim 1, wherein the cleaning member is provided so as to cover the entire circumference of the conveying screw in its axial circumferential direction.

3. The charging device according to claim 1, wherein the handle is attached to a conveying screw side such that the handle is rotatable relative to the conveying screw in the axial circumferential direction of the conveying screw.

4. The charging device according to claim 1, wherein the cleaning member includes a cleaning pad to be brought into contact with the discharging member, and
wherein the charging device further comprises an operating mechanism configured to cause the cleaning pad to be separated from the discharging member when the cleaning member is located at the home position, and to cause the cleaning pad to come into contact with the discharging member when the cleaning member is moved from the home position.

5. The charging device according to claim 4, wherein the operating mechanism includes a rotary shaft configured to enable operation of the cleaning pad, and
wherein the cleaning pad is separated from the discharging member or brought into contact with the discharging member by rotation of the rotary shaft.

6. The charging device according to claim 4, wherein the cleaning member includes a plurality of cleaning pads, and when in contact with the discharging member, the plurality of cleaning pads sandwich the discharging member to clean the discharging member.

7. The charging device according to claim 1, wherein the driving device includes a motor as a drive source, and the motor is rotatable in forward and reverse directions.

8. The charging device according to claim 1, further comprising a sensor to detect whether the cleaning member is located at the home position and a sensor to detect whether the cleaning member is located at a return position.

9. The charging device according to claim 1, further comprising a detecting device configured to detect whether the cleaning member is located at the home position or a return position by detecting an overcurrent in a motor, which serves as a drive source for the driving device, caused by physical contact of the cleaning member.

10. An image forming apparatus comprising:
a photoconductor;
the charging device according to claim 1 configured to charge the photoconductor;
an exposure device configured to form an electrostatic latent image on the photoconductor; and
a developing device configured to develop the electrostatic latent image with toner.

11. The image forming apparatus according to claim 10, further comprising:
a housing configured to accommodate the photoconductor, the charging device, the exposure device, and the developing device, and
a cover provided on the housing and configured to expose the handle in the housing when it is opened.

12. The image forming apparatus according to claim 11, wherein when the cover is closed, the handle is pressed by the cover and the cleaning member returns to the home position.

13. The image forming apparatus according to claim 10, wherein when the charging device is attached to a predetermined position around the photoconductor, the driving device and the conveying screw are connected to each other by a connecting member.

14. A method for cleaning a charging device, the charging device comprising:
a discharging member configured to carry out discharge to charge a photoconductor;
a cleaning member configured to clean the discharging member;
a conveying screw in the shape of a shaft and configured to move the cleaning member in a longitudinal direction of the discharging member and in an axial direction of the conveying screw when it is rotated;
a driving device configured to rotationally drive the conveying screw;
a detachable member that allows the driving device and the conveying screw to be attached to and detached from each other in a longitudinal direction of the conveying screw on a driving device side;
a shaft support member configured to rotationally support the conveying screw; and
a handle provided on an end portion side opposite to the driving device side in the longitudinal direction of the conveying screw, the handle configured to allow the cleaning member to be manually moved along the discharging member after the driving device and the conveying screw are disengaged by the detachable member,
wherein the cleaning member has a home position at the driving device side in the longitudinal direction of the conveying screw,
the method comprising the steps of:
operating the conveying screw with the handle to disengage or engage the conveying screw and the driving device through the detachable member, and
manually moving the cleaning member to clean the discharging member with the cleaning member.
